(19) United States
(12) Patent Application Publication
(10) Pub. No.: US 2009/0266258 A1
(43) Pub. Date: Oct. 29, 2009

(54) Method and System For Optimally Drying Ink On A Substrate Material

(75) Inventors: Jay Reichelsheimer, Shelton, CT (US); Bernard A. Richard, Norwalk, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/107,930

(22) Filed: Apr. 23, 2008

(51) Int. Cl. B41F 23/04; F26B 3/34

(52) U.S. Cl. 101/487; 34/275

(57) ABSTRACT

A method and system for optimally drying ink printed on the face of a substrate material. According to the method and system, a variable output dryer is provided having at least one variable output element for producing a plurality of dryer configurations. The method further includes the steps of depositing ink on the substrate material, reflecting light energy from the face surface of the printed ink while in a liquid state and measuring the intensity of the reflected light energy to yield a penetration time indicative of the time elapsed to dry the printed ink. The dryer is then adapted to assume one of the dryer configurations based upon the penetration time; and the ink printed on the face of the substrate material is dried by the variable output dryer.

### FIELD OF THE INVENTION

The present invention relates to a method and system for drying ink, and, more particularly, to a method and system for rapidly drying ink on substrate material which is stacked immediately following print operations. The invention prevents smearing/smudging as a consequence of the subsequent handling/stacking operations.

### BACKGROUND OF THE INVENTION

Automated mailpiece fabrication employs a variety of systems, devices and processes dedicated to perform specific sheet/media handling operations. These may include, inter alia, (i) mailpiece inserters dedicated to insert/fill envelopes with mailpiece content material, (ii) mailing machines/meters adapted to perform additional processing tasks such as moistening/sealing the envelope flap, weighing the completed/finished mailpiece, and applying/printing postage indicia for mailpiece delivery and (iii) envelope printing apparatus (both in-line and shuttle type) adapted to rapidly print mailpiece information (e.g., destination and return addresses) on a face of the envelope. When processing a small number of mailpieces or insufficient number to obtain “sorted mail” discounts (i.e., available through the Manifest Mailing System (MMS)), printed mailpieces are typically allowed to randomly fall into an open container. Alternatively, when printing a large number of conventional-size mailpieces (i.e., No. ten envelopes) eligible for USPS sorted mail discounts, the printed mailpieces may be neatly shingled and stacked for subsequent containment within a tray container.

The process of stacking/arranging mailpieces suitable for sorted mail discounts may be performed by a conveyor stacker, such as the type described in Sloan Jr. et al. U.S. Pat. No. 6,817,608. The stacker is an upright module having a conveyor system (i.e., a deck defined by one or more conveyor belts) which is disposed adjacent to, and essentially co-planar with, the output of the mailpiece printer. The conveyor system defines a feed path which is at right angles to, or essentially orthogonal with, the output path of the printer and includes stepped upstream and downstream segments. The upstream segment is vertically raised and operates at an increased speed relative to the downstream segment. As mailpieces exit the printer, the conveyor deck of the upstream segment receives mailpieces such that a space or gap is created between adjacent mailpieces. As the mailpieces move from the upstream to downstream segments, the mailpieces traverse a vertical step produced by the height differential between the segments. Inasmuch as the conveyor speed of the downstream segment is reduced relative to the upstream segment, mailpieces fall one atop another and shingle as the downstream segment slowly moves the mailpieces away from the vertical step. As the mailpieces continue downstream, a wedge or stacking ramp causes the mailpieces to assume an on-edge orientation to augment the removal and stacking of mailpieces within a tray container.

In addition to effecting the desired mailpiece arrangement and orientation, the conveyor stacker may include a high-output dryer for the purpose of drying the ink printed on the face of each mailpiece. The dryer is disposed over the conveyor deck of the upstream conveyor segment and produces a high-temperature flow of air over the face of each mailpiece. More specifically, the dryer includes a resistive heating element, one or more propulsive fans for directing ambient air over and around the heating element, and a louvered register for ducting the heated air over the mailpieces at a desired angle. With respect to the latter, the louvers of the register are disposed at an acute angle relative to the plane (i.e., substantially horizontal plane) defined by the underlying mailpieces. Specifically, the louvers are disposed at an angle of about thirty-five (35) degrees relative to the horizontal. As such, a horizontal component of the resultant airflow vector is produced which lies parallel to, and in the same direction as, the conveyor deck (i.e., movement of the mailpieces). A conveyor stacker, such as the type described above, is produced by Pitney Bowes Inc. of Stamford, Conn. under the tradename “DA400 Dryer/Stacker”.

The dryer functions to rapidly evaporate the ink solvent, thereby preventing the opportunity for the printed ink to smear or smudge when the face surfaces of the mailpieces are juxtaposed and/or contiguous, i.e., upon being shingled, raised on-edge and stacked. It will, therefore, be appreciated that the rate of mailpiece stacking is not solely a function of the conveyor deck speed, i.e., the speed of the upstream and downstream segments, but also a function of the rate of ink drying.

The rate of ink drying and associated print quality (e.g., the sharpness of the images edges) on the face of an envelope is a function of variety of factors including the efficacy of the drying apparatus, the characteristics of the ambient environment, and the properties of both the envelope and the ink. With respect to the dryer, factors include (i) the radiant heat energy produced by the heating element, (ii) the convective heat transfer between the heating element and the airflow produced by the propulsive fan(s), (iii) the convective heat transfer between the ink and the heated airflow due to the rate of air flowing over the envelope, i.e., the quantity of air moved by the propulsive fan(s), (iv) the convective heat transfer between the ink and the heated airflow due to the direction of air flowing over the envelope, i.e., through the louvers of the register, and (v) the proximity of the heating element to the envelope, i.e., the separation distance therebetween.

With respect to the characteristics of the ambient environment, factors include the ambient air conditions surrounding the dryer. For example, should humid conditions exist, e.g., 70% latent heat, evaporation will occur slowly and, so too, will the rate of ink drying. Concerning the properties of the paper and/or ink, factors affecting the drying time include, inter alia, (i) the type of paper and/or coatings used in the fabrication of the envelope, e.g., flat, satin, or glossy finish, etc., (ii) the evaporative properties of the ink solvent, and (iii) the viscous/molecular properties of the ink e.g., properties of the ink to flow, surface tension etc. With respect to the viscous/molecular properties, a low viscosity, low surface tension ink will flow, spread or flatten when a bead or drop is applied to a surface. That is, the diameter and/or area of a circular drop will enlarge under the forces of gravity and/or due to the lack of strong intermolecular bonds. This increased area has the effect of increasing the surface area available for heat transfer, wicking action (into the underlying substrate material), and evaporation. Hence, an advantage of low viscosity/surface tension inks is their ability to dry rapidly. A disadvantage, however, relates to a decrease in edge sharpness, and commensurate reduction in print quality and optical density.

Dryers of the prior art offer a single solution to drying ink, i.e., a fixed geometric configuration for a variable set of conditions. Such prior art dryers are, therefore, non-optimum whenever unique conditions exist, or, alternatively, wherever conditions differ from those originally addressed by the dryer. For example, should a high viscosity, slow drying ink be employed to print envelopes, prior art dryers may be unable to provide the necessary heat transfer necessary to dry the ink, i.e., before contact between mailpieces causes smearing or smudging. Alternatively, prior art dryers may produce more than sufficient heat output to dry a low viscosity, fast drying ink. Consequently, an opportunity to reduce the power consumed by the dryer may be lost. Furthermore, the envelope itself might contain a plastic window or its contents may be sensitive to heat thus requiring a lower heat setting, whereas the ink can be dried by increasing the airflow rate.

A need therefore exists, to provide a method and system for optimized drying of ink on a substrate material to produce an optimum heat output based upon a variety of sensed parameters.

### SUMMARY OF THE INVENTION

A method and system is provided for optimally drying ink printed on the face of a substrate material. According to the method and system, a variable output dryer is provided having at least one variable output element for producing a plurality of dryer configurations. The method further includes the steps of depositing ink on the substrate material, reflecting light energy from the face surface of the printed ink while in a liquid state and measuring the intensity of the reflected light energy to yield a penetration time indicative of the time elapsed to dry the printed ink. The dryer is then adapted to assume one of the dryer configurations based upon the penetration time; and the ink printed on the face of the substrate material is dried by the variable output dryer. In one embodiment, the penetration time may be determined in advance of a print job being initiated and prior to the step of adapting the variable output dryer. In another embodiment, the penetration time may be determined in the course of performing a print job such that the variable output dryer is reconfigured during the course of the print job.

### BRIEF DESCRIPTION OF THE DRAWINGS

Further details of the present invention are provided in the accompanying drawings, detailed description, and claims.

FIG. 1 is a flow diagram of method steps employed when practicing various teachings of the present invention.

FIG. 2 is a top view of a mailpiece stacker having a dryer capable of varying its output based upon the print characteristics of a print job.

FIG. 3 is a schematic side view of the variable output dryer including a system processor for controlling various reconfigurable elements/components of the dryer.

FIG. 4 is a schematic view of a sensing device for measuring a penetration time indicative of the time elapsed to dry the deposited ink.

FIG. 5 depicts a graphical output of a time vs. light intensity profile for determining the penetration time for a particular ink.

FIG. 6 depicts the method steps employed in the practice of another embodiment of the invention.

### DETAILED DESCRIPTION

A method and system for optimally drying ink will be described in the context of a mailpiece dryer/stacker, though the invention is not limited to drying ink printed on mailpieces or to sheet material conveyed on a stacking device. The stacker/dryer is merely illustrative of a useful adaptation of the inventive teachings and the invention should be interpreted broadly in the context of the specification and appended claims.

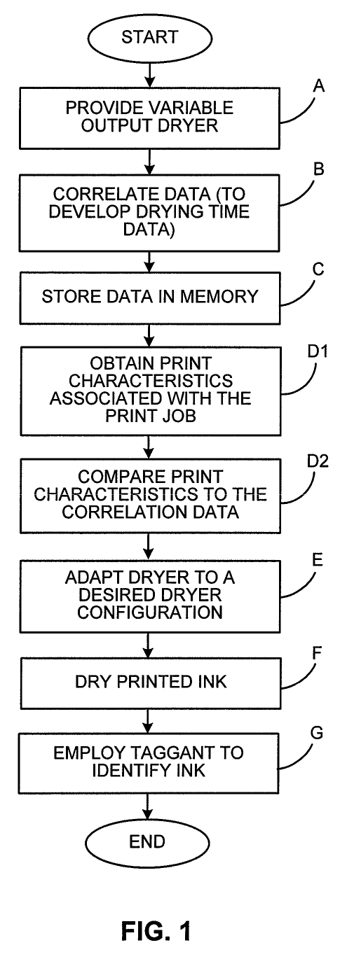

In FIG. 1, a flow diagram illustrates the principle method steps employed to practice one embodiment of the invention. In a first step A, a variable output dryer (described in greater detail below) includes at least one drying/heating element which may be controlled or reconfigured to vary the output of the dryer. As such, the variable output dryer has a plurality of dryer configurations each capable of a different output. Furthermore, in the context used herein, a “plurality of dryer configurations” includes more than one configuration, or an infinitely variable number of configurations, having a variety of output results/settings. In step B, data is developed (i.e., drying time data) to correlate various dryer configurations with at least one print characteristic employed when printing on a substrate material such as a mailpiece envelope. While the various print characteristics will be discussed at length in the subsequent paragraphs, such print characteristics relate to any (i) property of the ink, (ii) construction of the underlying substrate material influencing the absorption or flow of ink, or (iii) print commands impacting the amount of ink deposited on the substrate material, which impact drying.

Once this data is collected and analyzed, the data is stored and/or organized in a memory storage device, in a step C, for use by a system processor. When performing a particular print job, the specific or pertinent print characteristics associated with the print job are obtained or retrieved in a step D1. Further, in step D2, the print characteristic is compared with the developed data to define a dryer configuration. In step E, the variable output dryer is adapted to assume the dryer configuration based upon the print characteristic and the print job is executed in Step F to dry the ink printed on the substrate material. In an alternate embodiment of the invention, a taggant may be employed in a step G to identify the ink and its ink properties to augment the efficacy of the drying process and operation of a stacker/dryer. The following description discusses each of the foregoing steps in greater detail.

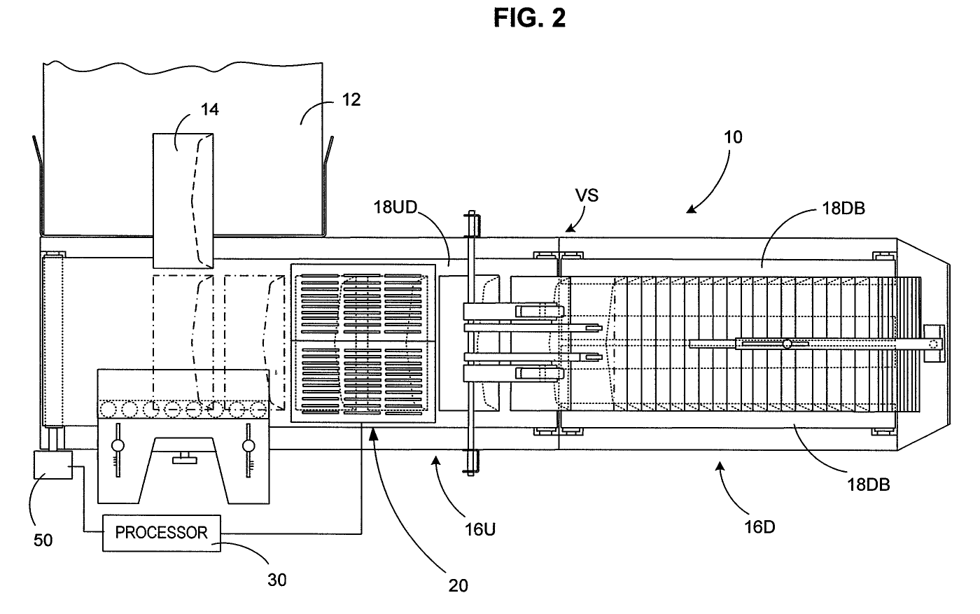

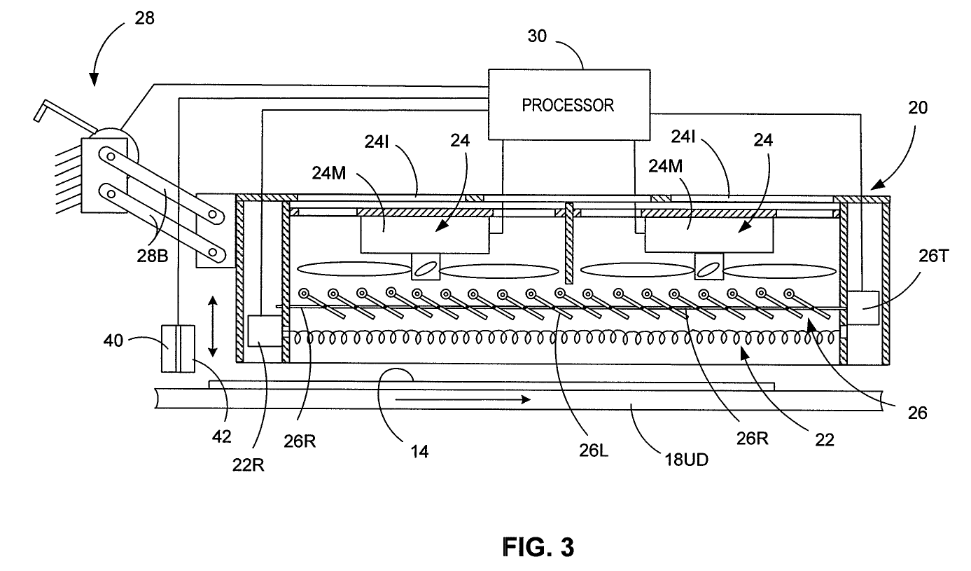

In FIGS. 2 and 3, a stacker/dryer 10 is disposed adjacent to a mailpiece printer 12 for receiving printed mailpieces 14. The mailpiece printer 12 may be configured for shuttle or in-line printing, though an in-line printer, i.e., a printer having print heads/cartridges dedicated to specific “print zones”, is generally preferable for high output print jobs. The stacker dryer 10 includes upstream and downstream conveyor segments 16U, 16D wherein the upstream segment is raised relative to the downstream segment to produce a vertical step VS between the segments 16U, 16D. Furthermore, a single conveyor deck 18UD associated with the upstream segment 16U travels at a relative high feed rate (i.e., relative to the feed rate of a plurality of downstream belts 18DB) to effect a small space/gap between mailpieces 14 as they are laid on the deck 18UB. That is, individual mailpieces 14 are laid without stacking or shingling of mailpieces on the upstream conveyor segment 16U. As the mailpieces 14 move from the upstream to downstream segments 16U, 16D, the lower feed rate of the downstream belts 18DB causes the mailpieces 14 to collect, stack and shingle. Furthermore, the vertical step VS between the segments 16U, 16D augments the stacking of mailpieces 14 by accommodating the requisite change in vertical height, i.e., from one mailpiece 14 to the next.

In advance of the vertical step VS, the upstream conveyor segment 16U includes a variable output dryer 20 disposed over and proximal to the conveyor deck 18UD. In FIGS. 1 and 2, the variable output dryer 20 includes (i) a heating element 22, (ii) propulsive fans 24 operative to direct air flow across the heating element 22, (iii) a ducting register 26 for directing air flow over each mailpiece 14, (iv) a mounting means 28 operative to vary the proximity of the dryer relative to an underlying mailpiece 14, and (v) a means 30 for controlling each of the foregoing elements/items, 22, 24, 26, 28, to vary the output of the dryer 20.

More specifically, the power/energy supplied to the heating element 22 may be varied by a conventional voltage rheostat 22R. Similarly, the speed of the propulsive motor 24M may be varied to change the flow rate i.e., measured in Cubic-Feet/Min (CFM) of the propulsive fan 24. Alternatively, the in-flow of air to the propulsive fan 24 may be restricted or permitted to flow more freely. Such flow variation may be effected by a moveable plate (not shown) disposed over the in-flow air apertures/slots 241 to regulate the air flowing into the propulsive fan 24. A Linear Variable Displacement Transducer (LVDT) 26T may displace a rod 26R which connects to each louver 26L of the ducting register 26. Linear displacement of the rod 26R collectively pivots the louvers 26L to direct the air flow exiting the dryer 20. Finally, the proximity of the dryer 20 to an underlying mailpiece 14 may be controlled by varying the angular position of a four-bar linkage arrangement 28B. The four-bar linkage 28B mounts the dryer 20 to a stationary housing structure (not shown) and effects linear displacement of the dryer 20 upon rotating a pivoting shaft of the linkage 28B. The means 30 for controlling the various elements/items 22, 24, 26, 28 is a conventional processor and will be discussed in greater detail when describing the steps and operation of the inventive method.

The variable output dryer 20 may be adapted to assume various configurations which change, e.g., intensify or ameliorate the dryer output. For example, one dryer configuration may include: (1) a mounting arrangement 28 configured to position the dryer 20 two inches (2″) above the conveyor deck, (2) a heating element 22 set to consume/generate two-thousand watts (2000 W) of power, (3) propulsive fans 24 driven to move air at a rate of 300 Cubic-Feet/Min (CFM), and (4) a ducting register 26 having louvers 26L positioned at fifteen degrees (15°) to optimally move air across the mailpiece 14. Others may include various power settings for the heating element, e.g., 1500 W, 2000 W, and 2500 W, a plurality of fan settings, e.g., 250, 300 and 400 CFM, a range of louver positions e.g., 35°, 25° and 15°, and multiple dryer position settings relative to the mailpiece 14, e.g., 2″, 2.5″ and 3″.

In addition to the various configurations of the variable output dryer 20, the information printed on the face of the mailpiece 14 can have various print characteristics which affect the rate of ink drying. As used herein, a “print characteristic” is any property of the ink, print process/command or fabrication/construction of the underlying substrate which can influence the rate or time taken to dry the ink on the substrate material. These print characteristics may include the type of ink employed when printing, the manner in which the printer/print driver deposits the ink, and/or the type/kind of paper used to fabricate an envelope. With respect to the former, and as previously discussed in the Background of the Invention, the ink may be viscous, i.e., resistant to fluid flow, and, consequently, slow drying. Similarly, the ink may exhibit intermolecular bonds, i.e., surface tension properties, tending to maintain a nearly spherical shape. These molecular bonds resist forces tending to spread or increase the surface area of a droplet of ink. As such, less surface area is available for evaporation to the ambient environment and/or for wicking/absorption by the substrate fiber-matrix (discussed in greater detail below). Alternatively, the printed ink may include a highly evaporative solvent, such as Methyl-Ethyl Ketone (MEK), which can accelerate the rate of ink drying.

With respect to the manner in which the printer deposits the ink, the various print settings will impact the amount of ink deposited and the rate of drying. For example, a “regular” print type will dry more rapidly than a “bold” print type. A fifty-percent (50%) grey-scale setting will dry faster than a ninety-percent (90%) grey-scale setting. And, a high resolution print command, e.g., 600 dots per inch (dpi), will produce print which requires more time to dry than a lower resolution print, e.g., 300 dots per inch (dpi). It will be appreciated that the foregoing print characteristics are directed to the amount of ink deposited rather than the properties of the ink and/or substrate material.

The physical makeup of the substrate can affect the drying rate. The type of fibers in the substrate material, the matrix which binds the fibers, or any fillers used can effect a wicking action which increases or decreases the rate of drying. For example, a highly absorbent “flat” substrate material will tend to be porous, i.e., have voids between the reinforcing fibers, and freely receives the flow of ink. In addition to the bulk absorption of the ink, the capillary action caused by the voids can pull the ink into the substrate and decrease the dry time. Conversely, a substrate material which is coated or less absorbent, e.g., wax paper, is less porous and slows the drying process. That is, a high resin/adhesive content binding matrix will tend to fill the voids and decrease the influx of ink. Furthermore, if the ink does not absorb, the ink must dry mainly through evaporation causing drying at a slower pace.

Once the configurations of the variable output dryer are known and the print characteristics are classified, empirical and/or analytical data may then be generated to correlate the various dryer configurations with the print characteristics. Further, this data will be used to determine the time required for drying and the optimum dryer configuration for a particular print job. For example, a fast drying ink may enable the stacker to increase throughput, i.e., number of mailpieces dried & stacked per unit time, by increasing the speed of its conveyor belts. Alternatively, a trade-off between throughput and power consumption may be warranted. Consequently, the conveyer belts may be slowed to decrease the output power required, i.e., of the variable output dryer, and yield a more suitable/optimum solution.

Tables I through IV below are illustrative of the various data/information which may be obtained to practice the teachings of the inventive method and system. These Tables are intended to provide a small sample of each data set and are not intended to provide an exhaustive/complete set of data which may be used in the method and system of the present invention. From this point of reference, Table I provides data relating to the various dryer configurations which may be analyzed. Configurations which vary the power to the heating element (Column 2), fan speed (Column 3), the in-flow area to the fan(s) (Column 4), the louver angle of the ducting register (Column 5) and separation distance between the dryer and the mailpiece (Column 6), are among those which may be tested.

Table II provides data/information relating to the various inks which may be employed. The properties of interest may include the color of the ink (Column 2), the ink viscosity (Column 3), and the surface tension properties (Column 4). A taggant (Column 5) may also be employed (discussed in greater detail below) to identify the ink. Tables III and IV provide data/information relating to the print process and substrate material, respectively. In Table III, printer data relating to the print font (Column 2), print type (Column 3) and print resolution (Column 4) may be useful to determine the amount of ink deposited on the substrate material. Table IV relates to the types of substrate material which may be more or less absorbent.

TABLE I
VARIABLE OUTPUT DRYER CONFIGURATION

| | | | IN- | | |
|---|---|---|---|---|---|
| CONFIG. | HEATING | FAN | FLOW | LOUVER | SEPARATION |
| NUMBER | ELEMENT | SPEED | AREA | ANGLE | DISTANCE |
| 1 | 2000 W | 50 CFM | 20 in² | 15 degrees | 2.0 inches |
| 2 | 2000 W | 50 CFM | 20 in² | 25 degrees | 2.0 inches |
| 3 | 2000 W | 50 CFM | 20 in² | 35 degrees | 2.0 inches |
| 4 | 2500 W | 50 CFM | 20 in² | 15 degrees | 3.0 inches |
| 5 | 2500 W | 50 CFM | 20 in² | 25 degrees | 3.0 inches |
| 6 | 2500 W | 50 CFM | 20 in² | 35 degrees | 3.0 inches |
| 7 | 3000 W | 50 CFM | 20 in² | 15 degrees | 4.0 inches |
| 8 | 3000 W | 50 CFM | 20 in² | 25 degrees | 4.0 inches |
| 9 | 3000 W | 50 CFM | 20 in² | 35 degrees | 4.0 inches |
| 10 | 2000 W | 60 CFM | 20 in² | 15 degrees | 2.0 inches |
| 11 | 2000 W | 60 CFM | 20 in² | 25 degrees | 2.0 inches |
| 12 | 2000 W | 60 CFM | 20 in² | 35 degrees | 2.0 inches |
| 13 | 2500 W | 60 CFM | 20 in² | 15 degrees | 3.0 inches |
| 14 | 2500 W | 60 CFM | 20 in² | 24 degrees | 3.0 inches |
| 15 | 2500 W | 60 CFM | 20 in² | 35 degrees | 3.0 inches |
| 16 | 3000 W | 60 CFM | 20 in² | 15 degrees | 4.0 inches |
| 17 | 3000 W | 60 CFM | 20 in² | 25 degrees | 4.0 inches |
| 18 | 3000 W | 60 CFM | 20 in² | 35 degrees | 4.0 inches |

TABLE II
INK CHARACTERISTICS AND IDENTIFIER

| | | | SURF. | | |
|---|---|---|---|---|---|
| | INK | INK | TENSION | EVAPORATIVE | |
| NUMBER | COLOR | VISCOSITY | PROPERTIES | SOLVENT | INK TAGGANT |
| 1 | Black | 1 PA-S | 35 DYNES/CM | 90% H20-10% IAL | Florescent Blue |
| 2 | Black | 3 PA-S | 35 DYNES/CM | 90% H20-10% IAL | Florescent Orange |
| 3 | Black | 10 PA-S | 35 DYNES/CM | 90% H20-10% IAL | Florescent Red |
| 4 | Black | 3 PA-S | 50 DYNES/CM | 90% H20-10% IAL | Florescent Yellow |
| 5 | Black | 10 PA-S | 50 DYNES/CM | 90% H20-10% IAL | Florescent Green |

TABLE III
PRINTER CHARACTERISTICS

| | | | PRINT |
|---|---|---|---|
| NUMBER | PRINT FONT | PRINT TYPE | RESOLUTION |
| 1 | ARIAL | REGULAR | 200 dpi |
| 2 | ARIAL | BOLD | 200 dpi |
| 3 | ARIAL | ITALIC | 200 dpi |
| 4 | ARIAL | REGULAR | 300 dpi |
| 5 | ARIAL | BOLD | 300 dpi |
| 6 | ARIAL | ITALIC | 300 dpi |
| 7 | ARIAL | REGULAR | 600 dpi |
| 8 | ARIAL | BOLD | 600 dpi |
| 9 | ARIAL | ITALIC | 600 dpi |
| 10 | ARIAL | REGULAR | 200 dpi |
| 11 | ARIAL | BOLD | 200 dpi |
| 12 | ARIAL | ITALIC | 200 dpi |
| 13 | ARIAL | REGULAR | 300 dpi |
| 14 | ARIAL | BOLD | 300 dpi |
| 15 | ARIAL | ITALIC | 300 dpi |
| 16 | ARIAL | REGULAR | 600 dpi |
| 17 | ARIAL | BOLD | 600 dpi |
| 18 | ARIAL | ITALIC | 600 dpi |

TABLE IV
PAPER CHARACTERISTICS

| NUMBER | PAPER TYPE |
|---|---|
| 1 | REGULAR FLAT |
| 2 | MEDIUM SATIN |
| 3 | GLOSSY |
| 4 | HIGH GLOSS |

The data shown in the Tables I through IV above may be loaded and stored in a relational database of the processor 30, e.g., look-up tables. Table V below provides a look-up table of the drying times based upon the data of Tables I through IV. That is, various dryer configurations, i.e., Table I, are tested and analyzed in combination with the various print characteristics, i.e., Tables II, III and IV, to develop the various drying times.

TABLE V
DRYING TIME

| DRYER | | | | | |
|---|---|---|---|---|---|
| CONFIGURATION | INK | PRINT | PAPER | DRYING TIME | |
| 1 | 1 | 1 | 1 | 5 | seconds |
| 1 | 1 | 1 | 2 | 8 | seconds |
| 1 | 1 | 1 | 3 | 10 | seconds |
| 1 | 1 | 1 | 4 | 16 | seconds |
| 1 | 2 | 1 | 1 | 6 | seconds |
| 1 | 2 | 1 | 2 | 9 | seconds |
| 1 | 2 | 1 | 3 | 12 | seconds |
| 1 | 2 | 1 | 4 | 20 | seconds |
| 1 | 3 | 1 | 1 | 6 | seconds |
| 1 | 3 | 1 | 2 | 10 | seconds |
| 1 | 3 | 1 | 3 | 14 | seconds |
| 1 | 3 | 1 | 4 | 22 | seconds |
| 1 | 4 | 1 | 1 | 6 | seconds |
| 1 | 4 | 1 | 2 | 10 | seconds |
| 1 | 4 | 1 | 3 | 14 | seconds |
| 1 | 4 | 1 | 4 | 22 | seconds |
| 2 | 1 | 1 | 1 | 3 | seconds |
| 2 | 4 | 1 | 2 | 5 | seconds |

In FIG. 3, the method and system of the present invention also includes a means for determining the print characteristics associated with a particular print job. That is, the processor 30 receives information (i.e., whether by direct operator input, sensed signals or a combination thereof) pertaining to the particular print job. This may include only one of the print characteristics, e.g., the type of ink used, or all characteristics including the print font, print type, resolution, paper type, etc.

In one embodiment of the present invention, a taggant may be introduced into the ink, i.e., in the ink cartridge, for identifying the ink. In the context used herein, a “taggant” is any chemical or physical marker added to the ink to facilitate testing and identification. The taggant may include a fluorescent pigment or dye introduced into the ink which responds to irradiation by light or other source of energy. The taggant may include magnetic or conductive particles suspended in the ink. For example, colloidal silver could be employed for detection in the presence of an electromagnetic field. Other examples include the use of copper, gold, cadmium, iron, etc. Taggants of the type described should be maintained at low concentration levels so as to avoid changes to the bulk ink properties. In the described embodiment, the ink may include a fluorescent dye which responds to a source 40 of irradiation. Energy irradiated/released from the dye as its molecules return to their previously unexcited state is sensed by a detector 42 disposed upstream of the dryer 20. Having detected the ink, the processor 30 determines an optimum dryer configuration for the stacker 10 and issues signals to the various devices, e.g., the rheostat 26R, fan motor 24M, louver LVDT 26T, to configure the dryer 20 accordingly. While the optimum dryer configuration may frequently correlate to the shortest drying time, the drying time may desirably be another time period, i.e., something longer than shortest period. For example, to conserve energy, a longer period to dry the ink may be an acceptable alternative. The rules of optimization will be different depending upon the needs of a particular operator e.g., time available, and will not be discussed in greater detail herein. It is suffice to say that algorithms using rule-based logic will be employed to select the requisite drying time. However, upon selecting the drying time, the correlation data of the present invention is used to achieve the optimum dryer configuration.

The method and system may be also used to vary the speed of the upstream and/or downstream conveyor belts. More specifically, conveyor belt motors 50 may be responsive to the processor 30 to increase or decrease the speed of the upstream and/or downstream belts. For example, a fast drying ink may enable additional mailpieces to be processed/stacked. Alternatively a slow drying ink may require that the speed of the downstream conveyor belt be increased to effect greater shingling between mailpieces, i.e., to prevent the ink of one mailpiece from contacting a surface of an adjacent mailpiece. Furthermore, since the speed of the conveyor belt impacts the time of ink exposure, i.e., exposure to the variable output dryer, a simple velocity calculation may be required to ensure adequate ink exposure. That is, the velocity of the mailpiece under the dryer must be taken into consideration, i.e., when constructing the optimization rules, to ensure that the ink will be exposed for the selected drying time.

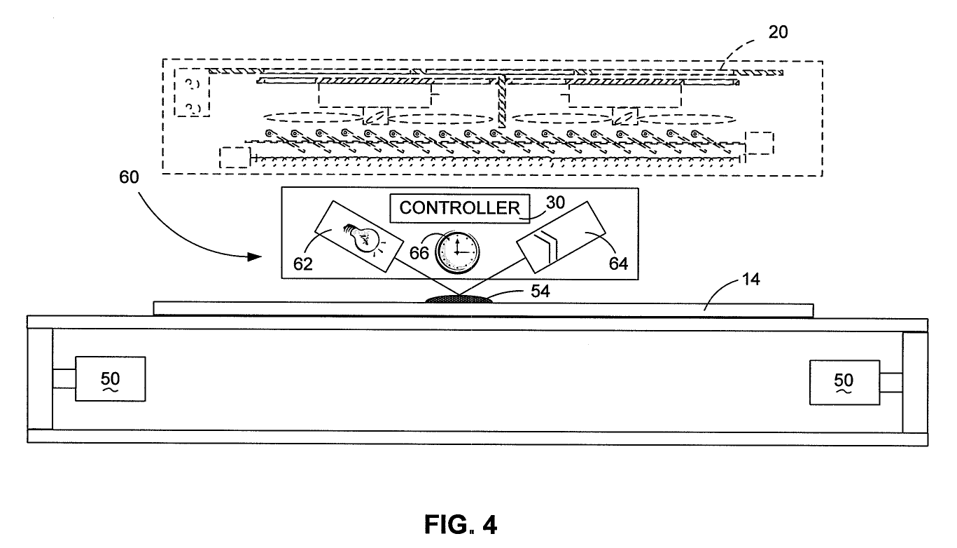

In yet another embodiment of the invention, information concerning the drying time for a particular ink may be measured/sensed to improve the accuracy of the various look-up Tables I through IV or as a substitute therefor, i.e., rather than using the correlated data. In this embodiment, and referring to FIG. 4, the variable output dryer 20 may be controlled or reconfigured based upon the actual drying time of ink 54 deposited on the substrate material 14. In this embodiment, a sensing device 60 may be employed upstream of the variable output dryer 20, i.e., between the printer and the variable output dryer 20, or in combination with the variable output dryer 20, to measure the actual drying time of the ink 54 printed on the substrate material 14. With this information, an amount of heat or heated airflow may be calculated to optimally reconfigure the variable output dryer 20 or to vary the speed of the conveyor motors 50.

The sensing device 60 includes a light source 62 and an intensity sensor 64. for measuring the intensity of reflected light. More specifically, the light source 62 is arranged to illuminate the ink 54 printed on the substrate material 14. In the described embodiment, a Light Emitting Diode (LED) light source 62 is employed to illuminate the ink 54, however any light source which is directional, e.g., a collimated beam of light may be employed. While still in a liquid state, the ink 54 has reflective properties and a portion of the energy irradiated by the light source 62 may be reflected from the exposed surface of the liquid ink 54, e.g., at an angle generally equal to the angle of incidence. The intensity sensor 64, e.g., an photo-detector, is arranged to receive, and measure the intensity of, the reflected light energy. As the ink 54 begins to dry, i.e., by evaporation, a wicking/capillary action of the porous fibers or a combination thereof, the reflective properties diminish along with the intensity of the reflected light. A timing device/clock 66, internal to the intensity sensor 64, the processor 30 or other controller, may be used to calculate the penetration time, or the time required to dry the printed ink 54. As used herein, the “penetration time” may be defined as the time elapsed between a known starting point/condition to a moment in time when the intensity of reflected light diminishes to a threshold level or, alternatively. to a minimum value.

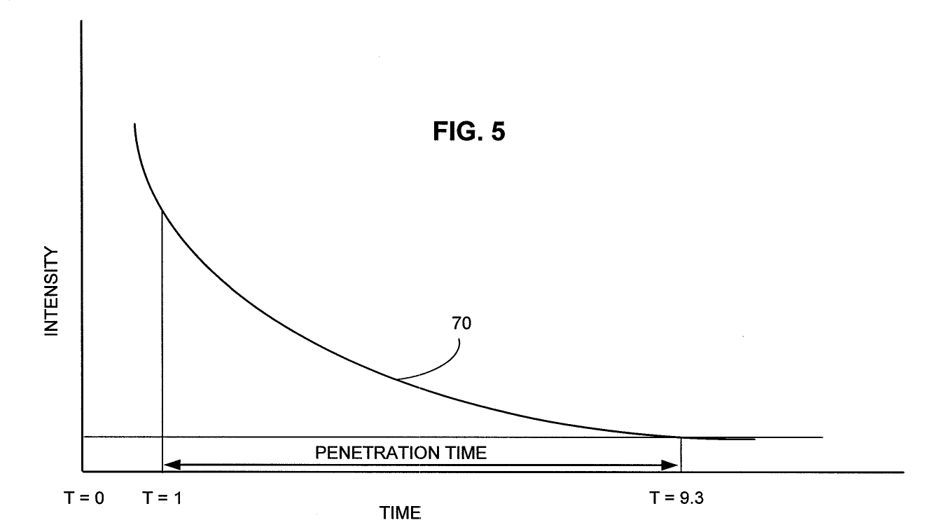

The authors of this invention determined that the reflectance/intensity profile of ink, i.e., the profile as ink changes from liquid to solid, was a valid and reliable measurement by performing experiments using a standard black pigment based ink on several envelope-type paper materials. A white LED light source was placed at forty-five degrees (45°) relative to the paper material and a light sensor was positioned at right angles relative to the beam produced by the LED light source. Each sheet of paper material was placed on a lab jack capable of raising and lowering the sheet relative to a syringe filled with the black ink. Raising the sheet resulted in contact with the syringe, deposition of a single drop of ink (i.e., approximately one microliter), as well as the start of a digital clock, e.g., a stop watch. The sheet was then lowered into the beam of LED light which was reflected in the direction of the light sensor. The reflected light was examined for gloss/intensity of reflected light energy and the penetration time elapsed was recorded. In this experiment, the penetration time was the time elapsed from the start of the digital clock until the gloss abated i.e., the reflected light energy/intensity stabilized to a minimum level/threshold. FIG. 5 depicts an exemplary reflectance profile 70 wherein the reflected light energy degrades or diminishes from a starting point/condition at T=1 second to a minimum value, or threshold, at T=9.3 seconds for a total penetration time of 8.3 seconds. This experiment was repeated six (6) times for each variety of paper material with the results being summarized in Table VI below.

TABLE VI
PENETRATION TIME

| PAPER | PENETRATION | PENETRATION |
|---|---|---|
| MATERIAL- | (DRYING) TIME | (DRYING) TIME |
| ENVELOPE | (AVG.) | (STD. DEV.) |
| A | 8.27 seconds | 1.60 seconds |
| C | 308.75 seconds | 58.00 seconds |
| G | 2.77 seconds | 0.33 seconds |

An examination of Table VI above reveals that the drying times vary significantly depending upon the type of paper used when printing. Furthermore, the experiments performed yielded reliable and consistent results with a maximum variance of approximately eighteen percent (˜18%).

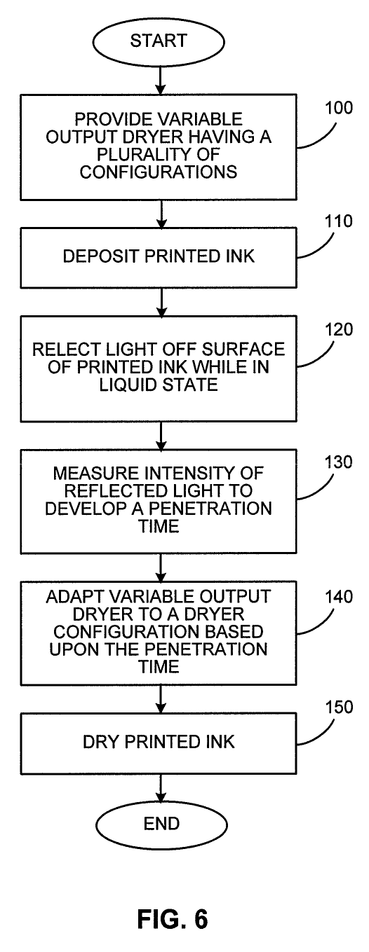

By using this approach in combination with the variable output dryer 20, the configuration of a dryer can be optimized. The method steps employed are depicted in the flowchart of FIG. 6 wherein a variable output dryer 20 is provided, in step 100, having a plurality of dryer configurations which may be adapted based upon the drying time of the printed ink 54. As discussed previously, the variable output dryer 20 may be adapted to vary its power supply, louver angle, rate of air flowing into and out of the dryer 20, and proximity of the dryer 20 to the substrate material 14.

In step 110, ink is deposited on the substrate material, and, in step 120, light energy is reflected from the surface of the printed ink 54 while in a liquid state. As mentioned previously, any collimated beam of light may be used as a light source. In step 130, the intensity of the reflected light energy is measured to yield a penetration time (similar to the profile 70 shown in FIG. 5) indicative of the time elapsed to dry the printed ink 54. Using this information, the variable output dryer 20 is adapted, in step 140 to assume one to assume one of the dryer configurations based upon the penetration time. In a final step 150, the substrate is passed under the variable output dryer to dry the printed ink.

The variable output dryer 20 can be preprogrammed to vary the dryer configuration as each printed sheet is passed under the dryer 20. For example, the variable output dryer 20 can be preprogrammed to increase the flow rate in a stepped function from forty (40) to sixty (60) CFM while monitoring the penetration time. If the drying time continues to increase, from one sheet to the next, the dryer configuration may increase the flow rate until a steady state condition is achieved, e.g., the recorded penetration time is constant from one measurement to the next. If the penetration time decreases, then another parameter may be changed such as the power supplied to the heating element of the variable output dryer 20. Alternatively, the speed of the conveyor belt may be increased or decreased to optimize the number of printed sheets dried per unit of time.

Additionally, the processor 30 may issue instructions to the printer to vary the characteristics of the printed ink 54. For example, the printer 12 may alter or vary the volume of ink deposited. This may be achieved by changing the pattern, number or size of the ink droplets produced or controlled by the print head. According the penetration time may be varied using several techniques including: (i) varying configuration of the dryer 20, (ii) altering the speed of the conveyor, and (iii) changing the characteristics of the printer 12.

It is to be understood that the present invention is not to be considered as limited to the specific embodiments described above and shown in the accompanying drawings. The illustrations merely show the best mode presently contemplated for carrying out the invention, and which is susceptible to such changes as may be obvious to one skilled in the art. The invention is intended to cover all such variations, modifications and equivalents thereof as may be deemed to be within the scope of the claims appended hereto.

1. A method for optimally drying ink printed on the face of a substrate material, comprising the steps of:
providing a dryer having at least one variable output element for producing a plurality of dryer configurations;
depositing ink on the substrate material;
reflecting light energy from the surface of the ink while in a liquid state;
measuring the intensity of the reflected light energy to determine a penetration time indicative of the time elapsed to dry the ink;
adapting the dryer to assume one of the dryer configurations based upon the penetration time; and,
drying the ink deposited on the face of the substrate material.

2. The method according to claim 1 wherein the step of reflecting light energy from the surface of the printed ink includes illuminating the printed ink using a collimated source of light.

3. The method according to claim 2 wherein the collimated source of light is produced by a light emitting diode (LED).

4. The method according to claim 1 wherein the penetration time is the time elapsed between a known starting condition to a moment in time when the intensity of reflected light diminishes to a threshold level.

5. The method according to claim 1 wherein the penetration time is the time elapsed between a known starting condition to a moment in time when the intensity of reflected light diminishes to a minimum value.

6. The method according to claim 1 wherein the step of adapting the dryer to the one of the dryer configurations includes the step of:
varying the power supplied to a heating element of the dryer.

7. The method according to claim 1 wherein the step of adapting the dryer to the one of the dryer configurations includes the step of:
varying the airflow produced by a propulsive fan in the dryer.

8. The method according to claim 1 wherein the step of adapting the dryer to the one of the dryer configurations includes the step of:
varying the louver angle of a ducting register in the dryer.

9. The method according to claim 1 the step of adapting the dryer to the one of the dryer configurations includes the step of:
varying the proximity of the dryer to the face surface of the sheet material.

10. The method according to claim 1 wherein the step of adapting the dryer to the one of the dryer configurations includes the step of:
varying the in-flow of air to a propulsive fan in the variable output dryer.

11. A system for drying printed ink on the face of an envelope, comprising:
a conveyor system including a conveyor deck and a motor for driving the conveyor deck, the conveyor deck operative to receive and convey the printed mailpiece envelope;
a dryer disposed over the conveyor deck and operative to dry the printed ink the mailpiece envelope, the dryer having at least one variable output element for producing a plurality of dryer configurations;
a sensing device operative to measure a penetration time indicative of the time elapsed to dry a printed ink from a liquid state; and
a processor operative to adapt the variable output dryer to a desired dryer configuration based upon the measured penetration time.

12. The system according to claim 11 wherein the sensing device includes:
a source of light energy for illuminating the surface of the printed ink while in a liquid state;
an intensity sensor operative to measure the intensity of light energy reflected from the surface of the printed ink and
a timing device for measuring the penetration time.

13. The system according to claim 12 wherein the variable output element includes a variable output heating element.

14. The system according to claim 12 wherein the variable output element includes a variable speed fan for providing air flow to a heating element.

15. The system according to claim 12 wherein the variable output element includes a ducting register having movable louvers and a connecting rod to vary the angle of the movable louvers.

16. The method according to claim 1 wherein the penetration time is determined in advance of a print job being initiated and prior to the step of adapting the variable output dryer.

17. The method according to claim 1 wherein the penetration time is determined in the course of performing a print job such that the variable output dryer is reconfigured during the course of the print job.

18. A method for optimally drying ink printed on the face of a substrate material, comprising the steps of:
depositing ink on the substrate material;
reflecting light energy from the surface of the ink while in a liquid state;
measuring the intensity of the reflected light energy to determine a penetration time indicative of the time elapsed to dry the ink; and
drying the ink deposited on the face of the substrate material.

19. The method according to claim 18 wherein the step of reflecting light energy from the surface of the printed ink includes illuminating the printed ink using a collimated source of light.

20. The method according to claim 19 wherein the collimated source of light is produced by a light emitting diode (LED).

21. The method according to claim 18 wherein the penetration time is the time elapsed between a known starting condition to a moment in time when the intensity of reflected light diminishes to a threshold level.

22. The method according to claim 18 wherein the penetration time is the time elapsed between a known starting condition to a moment in time when the intensity of reflected light diminishes to a minimum value.
